(19) United States
(12) Patent Application Publication
(10) Pub. No.: US 2011/0079204 A1
(43) Pub. Date: Apr. 7, 2011

(54) PISTON, CYLINDER BARREL OR OTHER ENGINE COMPONENT, PROXIMATE TO THE COMBUSTION CHAMBER OF AN INTERNAL COMBUSTION ENGINE, AND METHOD OF MANUFACTURE

(76) Inventor: Klaus Lades, Nurnberg (DE)

(21) Appl. No.: 12/999,675

(22) PCT Filed: Jun. 5, 2009
(86) PCT No.: PCT/EP2009/056940

§ 371 Date: Dec. 17, 2010

(30) Foreign Application Priority Data
Jun. 18, 2008 (DE) 10 2008 002 514.3

(51) Int. Cl. F02B 75/08; F02F 3/00; B23P 15/10

(52) U.S. Cl. 123/668; 123/193.6; 29/888.04

(57) ABSTRACT

A piston, a cylinder barrel or another engine component adjacent to the combustion chamber of an internal combustion engine comprises a layer or a coating facing the combustion chamber, the layer or coating comprising an aerogel. The method of manufacture of an engine component involves designing such a layer or the application of such a coating.

### FIELD OF THE INVENTION

The invention relates to a motor component such as a piston, a cylinder barrel or another engine component adjacent to the combustion chamber of an internal combustion engine, and a method of manufacture thereof.

In the field of internal combustion engines efforts are being undertaken to reduce wall heat loss and to thereby increase efficiency. Essentially, the attempt is being made to insulate the combustion chamber as well as possible or to make the combustion chamber “heat tight”. However, the problem to date has been that the additionally provided thermal energy leads to an enthalpy increase in the exhaust.

### PRIOR ART

The ceramic components or inserts used in light of the aforementioned background could not be used since they did not meet the requirements of mechanical strength.

GB 821822 A describes an engine which operates according to the Stirling or Ericsson process and includes a hollow displacement piston that can be filled with a silicate aerogel.

### DESCRIPTION OF THE INVENTION

The object forming the basis of the invention is to provide a piston, a cylinder barrel or another engine component adjacent to the combustion chamber of an internal combustion engine which meets the requirements in terms of mechanical strength and has at the same time an increased thermal insulation characteristic. Furthermore, a method of manufacturing the same is to be provided.

The object is solved by the subject matter of patent claim 1. Claim 1 refers to a piston, a cylinder barrel or another engine component adjacent to the combustion chamber of an internal combustion engine. For the sake of simplicity, the piston and cylinder barrels according to the invention are hereinafter also referred to as engine components.

This engine component is characterized in that it comprises a layer facing the combustion chamber, preferably an outermost layer, or a coating, said layer or coating comprising an aerogel. Hence, the aerogel can be found in an outer layer of the engine component. Alternatively, the aerogel can be applied as a separate coating to an engine component. Aerogels are highly-porous materials with low density which are prepared by forming a gel and subsequent removal of the liquid while largely maintaining the gel structure. Up to 95% of the volume can consist of pores. Aerogels have a highly dendritic structure, i.e. put differently, a ramification of chains of particles having a large number of interspaces in the form of open pores. The chains have many contact points, and therefore a stable, foamy net is formed.

In connection with the innovative coating of an engine component with an aerogel, there is the advantage that the desired effect of thermal insulation can be achieved without increasing enthalpy in the exhaust, and that the mechanical requirements are met at the same time.

Advantageous embodiments are described in the further claims.

The characteristics of the layer or coating according to the invention can be further improved and adapted to specific applications in that the layer or coating further comprises embedded particles such as e.g. carbon, SiC, SiO₂, TiO₂ or WC.

In particular, particles of this type can have the characteristic that the thermal insulation effect is increased or reduced such that the coating can be adapted individually to the requirements.

In view of the application of the coating according to the invention, further advantages are achieved if this coating comprises a resin such as, e.g., an epoxide or phenol resin. Thus, the coating can be applied more flexibly and with more adhesive strength.

The aforementioned object is, moreover, solved by the method described in claim 5. The preferred embodiments of the method correspond to the preferred embodiments of the coating according to the invention. Furthermore, the result of the first tests has revealed that the engine component according to the invention can be particularly well formed by thick- or thin-film technology.

Particularly preferred technologies in this case are injection, dipping, dip-coating, filling or spreading.

In the first tests good experience has also been obtained with an application of the coating by the sol-gel process.

1. Piston, cylinder barrel or other engine component adjacent to the combustion chamber of an internal combustion engine, comprising a layer or a coating facing the combustion chamber, said layer or coating comprising an aerogel.

2. Piston, cylinder barrel or engine component according to claim 1, wherein the layer or coating further comprises embedded particles such as carbon, SiC, SiO₂, TiO₂, or WC.

3. Piston, cylinder barrel or engine component according to claim 2, wherein the particles have the property to increase or reduce the thermal insulation effect.

4. Piston, cylinder barrel or engine component according to claim 1, wherein the layer or coating further contains a resin.

5. Method for manufacturing a piston, a cylinder barrel or other engine component adjacent to the combustion chamber of an internal combustion engine, in which a layer facing the combustion chamber is formed or a coating is applied, said layer or coating comprising an aerogel.

6. Method according to claim 5, wherein the coating is applied by thick- or thin-film technology.

7. Method according to claim 5 wherein the coating is applied by injection, dipping, dip-coating, filling or spreading.

8. Method according to claim 5, wherein the coating is applied by a sol-gel process.

9. Piston, cylinder barrel or engine component according to claim 4, wherein the resin comprises an epoxy or a phenol resin.
